(19) United States
(12) Patent Application Publication
(10) Pub. No.: US 2026/0328603 A1
(43) Pub. Date: Oct. 22, 2026

(54) ULTRA-LARGE DIAMETER STRAIGHT-THROUGH MULTI-CHANNEL ULTRASONIC FLUID MEASUREMENT DEVICE

(71) Applicant: SUZHOU DOJUSTEK INTELLIGENT TECHNOLOGY CO., LTD., Suzhou (CN)

(72) Inventors: Zhengrong SONG, Suzhou (CN); Yong SUN, Suzhou (CN); Kai HUA, Suzhou (CN)

(21) Appl. No.: 19/701,864

(22) Filed: Jun. 9, 2026

Related U.S. Application Data
(63) Continuation of application No. PCT/CN2024/136316, filed on Dec. 3, 2024.

(30) Foreign Application Priority Data
Mar. 23, 2024 (CN) 202410337581.1

(51) Int. Cl. G01F 1/66; G01F 1/667

(52) U.S. Cl. CPC G01F 1/662; G01F 1/667

(57) ABSTRACT

includes a measuring tube body with a plurality of transducer groups at two ends thereof, each transducer groups comprises two ultrasonic transducers arranged facing each other and located at two ends of the measuring tube body respectively, and all the ultrasonic transducers are distributed along a circumferential direction of the measuring tube body. A side wall of the measuring tube body is formed with a mounting hole, each ultrasonic transducer is inserted into the mounting hole, a surface of each ultrasonic transducer is provided with a positioning protrusion, which is inserted into a positioning groove in an inner wall of the mounting hole, and the measuring tube body is further provided with a locking assembly for fixing the positioning protrusion in the positioning groove. The locking assembly includes an elastic locking strip slidably arranged in the positioning groove.

### CROSS-REFERENCE TO RELATED APPLICATION

This application is a continuation of PCT application serial no. PCT/CN2024/136316, filed on Dec. 3, 2024, which claims the priority and benefit of Chinese patent application serial no. 202410337581.1, filed on Mar. 23, 2024. The entireties of PCT application serial no. PCT/CN 2024/136316 and Chinese patent application serial no. 202410337581.1 are hereby incorporated by reference herein and made a part of this specification.

### TECHNICAL FIELD

The present application relates to the technical field of fluid flow metering, and particularly, to an ultra-large diameter straight-through multi-channel ultrasonic fluid measurement device.

### BACKGROUND

An ultrasonic fluid measurement device may specifically be an ultrasonic flowmeter, which utilizes pairs of ultrasonic transducers to alternately (or simultaneously) transmit and receive ultrasonic waves toward each other (thus forming a measurement channel), indirectly measures a flow velocity of a fluid by observing a time difference of ultrasonic wave propagation in a fluid medium when traveling upstream or downstream, and then calculates a flow rate via the flow velocity.

Specifically, the ultrasonic fluid measurement device generally includes a measuring tube body and transducers. The measuring tube body is mounted on a water pipe via fastening components such as flanges. A side wall of the measuring tube body is formed with mounting holes extending therethrough. The transducers are arranged in pairs and fixedly inserted into the mounting holes respectively. The detecting ends of each pair of transducers are arranged facing each other to facilitate the transmission and reception of ultrasonic waves.

However, for an ultra-large diameter (usually referring to DN200 and above) straight-through ultrasonic fluid metering device, due to its large diameter, the flow regime in the pipe is highly susceptible to interference (e.g., influence of elbows, valves, unsteady flows, etc.), causing unstable flow velocities in different regions in the pipe. The aforementioned conventional ultrasonic fluid measurement devices (such as existing ultra-large diameter measurement devices such as the D400 and X-type single-layer sampling designs) have a single measurement channel, which is easily affected by upstream and downstream elbows, valves, etc., resulting in large measurement errors and poor accuracy.

### SUMMARY

In order to improve the measurement accuracy of a fluid flow in an ultra-large diameter pipe, the present application provides an ultra-large diameter straight-through multi-channel ultrasonic fluid measurement device.

The ultra-large diameter straight-through multi-channel ultrasonic fluid measurement device provided by the present application includes a measuring tube body, the measuring tube body is provided with a plurality of transducer groups, each of the plurality of transducer groups comprises two ultrasonic transducers arranged facing each other, the ultrasonic transducers of the plurality of transducer groups are arranged at two ends of the measuring tube body, the two ultrasonic transducers belonging to a same one of the plurality of transducer groups are located at the two ends of the measuring tube body respectively, and the ultrasonic transducers of the plurality of transducer groups are distributed along a circumferential direction of the measuring tube body when viewed from an end of the two ends of the measuring tube body.

By adopting the above technical solution, first, the present application provides a plurality of transducer groups, and each transducer group includes two ultrasonic transducers facing each other. In addition, when viewed the ultrasonic transducers from the end of the measuring tube body, all the ultrasonic transducers of the present application are distributed on the measuring tube body, thereby enabling measurement across different flow layer in the measuring tube body, and further optimizing the measurement accuracy of the fluid flow in the ultra-large diameter pipe. Secondly, all the ultrasonic transducers are located at the ends of the measuring tube body, thereby increasing the acoustic path length is extended, and thus improving the measurement dynamic range of the meter.

In one embodiment, an end surface of each of the ultrasonic transducers for transmitting and receiving ultrasonic waves is configured as an inclined end surface, and the inclined end surfaces of the two ultrasonic transducers belonging to a same one of the plurality of transducer groups are arranged facing each other.

By adopting the above technical solution, the oblique configuration of the end surfaces further increases the acoustic path length, further improves the measurement dynamic range of the meter, and thus optimizing the accuracy of ultrasonic fluid measurement.

In one embodiment, a side wall of the measuring tube body is formed with a mounting hole for each of the ultrasonic transducers, the mounting hole extends along a radial direction of the measuring tube body, each of the ultrasonic transducers is inserted into the mounting hole along a depth direction of the mounting hole, a surface of each of the ultrasonic transducers is provided with a positioning protrusion, an inner wall of the mounting hole is formed with a positioning groove for receiving the positioning protrusion, and the measuring tube body is further provided with a locking assembly for fixing the positioning protrusion in the positioning groove.

By adopting the above technical solution, the positioning protrusion and the positioning groove are configured to limit an insertion position and an insertion angle of the ultrasonic transducer when the ultrasonic transducer is inserted into the mounting hole, so that when the positioning protrusion is inserted into the positioning groove, the two ultrasonic transducers belonging to the same transducer group may face each other, thereby ensuring stable transmission and reception of ultrasonic waves.

In one embodiment, the locking assembly includes an elastic locking strip, a side wall of the positioning protrusion is formed with a first locking hole, the elastic locking strip is slidably connected to an inner wall of the positioning groove, and the locking hole is located in a sliding path of the elastic locking strip.

By adopting the above technical solution, after the positioning protrusion is inserted into the positioning groove, the elastic locking strip is moved so that it one end is inserted into the locking hole, thereby fixing the positioning protrusion in the positioning groove.

In one embodiment, the locking assembly further includes a plurality of mating protrusions, the plurality of mating protrusions and the positioning protrusions are arranged along a circumferential direction of each of the ultrasonic transducers, the inner wall of the mounting hole is formed with mating slots for receiving the plurality of mating protrusions, an elastic locking strip is provided between every two adjacent ones of the mating slots and between the positioning groove and a respective one of the mating slots adjacent to the positioning groove, respectively, the elastic locking strip comprises two side pieces and a mating elastic piece between the two side pieces, the first locking hole is configured for receiving a first one of the two side pieces, a side wall of each of the plurality of mating protrusions is formed with a second locking hole for receiving a second one of the two side pieces, when the two side pieces and the mating elastic piece are undeformed, an end of each of the two side pieces away from the mating elastic piece is inserted into a respective one of the plurality of mating slots or the positioning groove, and when the two side pieces are respectively inserted into the first locking hole and the second locking hole, both the two side pieces and the mating elastic piece are in an elastically deformed state.

By adopting the above technical solution, a fixed connection between the positioning protrusion and the positioning groove is achieved by combining two methods. By the first method, the side pieces are inserted into the locking holes respectively to achieve limiting. By the second method, an elastic force, which is generated when the mating elastic piece and the side pieces are elastically deformed, is utilized to stably insert the side pieces into the locking holes respectively, thereby stably inserting the positioning protrusion into the positioning groove, and thus achieving convenient and stable locking.

In one embodiment, the mounting hole is internally provided with a flexible sealing gasket, the flexible sealing gasket is located between a respective one of the ultrasonic transducers and the inner wall of the mounting hole, the flexible sealing gasket is formed with a through hole for a respective one of the ultrasonic transducers to extend through, a lower end of the mating elastic piece extends along a length direction of the mating elastic piece to an outer periphery of the flexible sealing gasket, when the mating elastic piece is undeformed, the mating elastic piece is attached to a peripheral wall of the flexible sealing gasket, and when the two side pieces are respectively inserted into the first locking hole and the second locking hole, the mating elastic piece bends and deforms toward the flexible sealing gasket and presses against the flexible sealing gasket.

By adopting the above technical solution, when the side pieces and the mating elastic piece are undeformed, the end of the respective side piece away from the mating elastic piece is inserted into the mating slot or the positioning groove. In the process that the mating protrusion is inserted into the mating slot and the positioning protrusion is inserted into the positioning groove, the mating protrusion inevitably presses against the side piece. At this time, the two side pieces of one elastic locking strip jointly press against the mating elastic piece, so that the mating elastic piece bends and deforms toward the flexible sealing gasket, thereby pressing against the flexible sealing gasket, and subsequently enabling the flexible sealing gasket to tightly abut against the side wall of the ultrasonic transducer. Moreover, the present application defines that “when the two side pieces are respectively inserted into the first locking hole and the second locking hole, both the two side pieces and the mating elastic piece are in an elastically deformed state”. Therefore, even after the assembly of the mating protrusion and the positioning protrusion is completed, the mating elastic piece remains pressing against the flexible sealing gasket, i.e., the flexible sealing gasket remains abutting against the surface of the ultrasonic transducer, and thus improving the sealing performance between the ultrasonic transducer and the mounting hole.

In one embodiment, a lower surface of the flexible sealing gasket facing the mating elastic piece is integrally formed with a mating sealing gasket, and the inner wall of the mounting hole is formed with a sealing groove for receiving the mating sealing gasket.

By adopting the above technical solution, the provision of the mating sealing gasket and the sealing groove increases the contact area between the flexible sealing gasket and the inner wall of the mounting hole, thereby improving the sealing performance of the flexible sealing gasket at a joint between the mounting hole and the ultrasonic transducer. By means of the mating sealing gasket and the sealing groove, in cooperation with the elastic force of the mating elastic piece, the sealing performance is further improved. Specifically, when the mating elastic piece presses against the flexible sealing gasket, the mating sealing gasket is pressed to abut against an inner wall of the sealing groove. By improving the sealing performance between the mating sealing gasket and the sealing groove, the sealing performance at the joint between the mounting hole and the ultrasonic transducer is further improved.

In one embodiment, each of the ultrasonic transducers is slidably connected within the mounting hole along the depth direction of the mounting hole, and the measuring tube body is provided with a driving member for fixing a sliding position of each of the ultrasonic transducers.

By adopting the above technical solution, the two ultrasonic transducers belonging to the same transducer group are moved simultaneously while maintaining their opposed arrangement (e.g., one moves toward the interior of the measuring tube body, and the other moves away from the measuring tube body). After sliding a predetermined distance, the driving member locks the sliding position. In this way, the measurement plans of the fluid can be further increased, which may reduce fluid measurement errors, thereby optimizing the measurement accuracy.

In one embodiment, an inner wall of the measuring tube body adjacent to the mounting hole is provided with a scraper, and the scraper is located at an outer periphery of a respective one of the ultrasonic transducers and attached to a peripheral wall of a respective one of the ultrasonic transducers

By adopting the above technical solution, the fluid flowing through the measuring tube body is highly likely to contact the surface of the ultrasonic transducer. For fluid containing impurities, the impurities tend to accumulate and adhere to the surface of the ultrasonic transducer, thereby impeding fluid flow, affecting flow velocities, and even affecting the transmission and reception of ultrasonic waves. Therefore, the scraper is provided to cooperate with the sliding movement of the ultrasonic transducer, creating relative movement between the scraper and the ultrasonic transducer. Since the scraper is attached to the surface of the ultrasonic transducer, the scraper can scrape the surface of the ultrasonic transducer during the relative movement between the scraper and the ultrasonic transducer, thereby cleaning the surface of the ultrasonic transducer.

In one embodiment, different quantities of transducer groups determine different ultrasonic propagation paths and generate different measurement planes, and ultrasonic transducers in the different quantities of transducer groups at the different measurement planes have end surfaces with different inclination angles.

In conclusion, the present application includes at least one of the following beneficial technical effects:

The present application adopts multiple pairs of ultrasonic transducers transmitting towards each other, which are uniformly distributed on a lateral cross-section of the measuring tube body to measure different fluid layers. The present application adopts specifically designed ultrasonic transducers with tilted end surfaces, allowing them to be inserted into the mounting holes perpendicularly to a radial direction of a pipe to be measured to realize opposed arrangement. Furthermore, the ultrasonic transducers are installed at the ends of the measuring tube body, thereby increasing the ultrasonic measurement acoustic path length and improving the measurement dynamic range of the meter. In addition, all the ultrasonic transducers located at a same one end of the measuring tube body share a single wiring conduit, thereby simplifying the overall wiring layout of the ultrasonic transducers.

### BRIEF DESCRIPTION OF THE DRAWINGS

FIG. 1 is a schematic structural view of the ultra-large diameter straight-through multi-channel ultrasonic fluid measurement device according to embodiment 1 of the present application.

FIG. 2 is a cross-sectional view along line A-A in FIG. 1.

FIG. 3 is a simplified diagram showing an arrangement position of the ultrasonic transducers relative to the measuring tube body according to Embodiment 1, as viewed from the end of the measuring tube body, when the paths of the ultrasonic transducers form an asterisk shape.

FIG. 4 is a simplified diagram showing an arrangement position of the ultrasonic transducers relative to the measuring tube body according to another embodiment, as viewed from the end of the measuring tube body, when the paths of the ultrasonic transducers form a four-stroke horizontal shape.

FIG. 5 is a simplified diagram showing an arrangement position of the ultrasonic transducers relative to the measuring tube body according to yet another embodiment, as viewed from the end of the measuring tube body, when the paths of the ultrasonic transducers form a grid-like shape.

FIG. 6 is a schematic view illustrating a positional relationship between an ultrasonic transducer and the mounting hole according to embodiment 2.

FIG. 7 is a schematic view illustrating a structure of a fixing ring block according to embodiment 2 of the present application.

FIG. 8 is a cross-sectional view illustrating a direct positional relationship among a mating protrusion, a positioning protrusion, and the fixing ring block according to embodiment 2 of the present application.

FIG. 9 is a cross-sectional view illustrating a positional relationship between a mating elastic strip and a flexible sealing gasket according to embodiment 2 of the present application.

FIG. 10 is a cross-sectional view illustrating a positional relationship between the ultrasonic transducer and the mounting hole according to embodiment 3 of the present application.

### DETAILED DESCRIPTION

Embodiments of the present application disclose an ultra-large diameter straight-through multi-channel ultrasonic fluid measurement device. As the name suggests, it is suitable for fluid measurement in large-diameter pipes, and particularly suitable for an ultrasonic water meter with a nominal diameter of DN100 and above. The ultra-large diameter straight-through multi-channel ultrasonic fluid measurement device of the present application can provide multi-plane measurement of a fluid to be measured, and this measurement mode is applicable to situations where the flow regime of the fluid to be measured is highly susceptible to disturbances. It is effective in reducing measurement errors, improving meter precision, and optimizing measurement accuracy.

### Embodiment 1

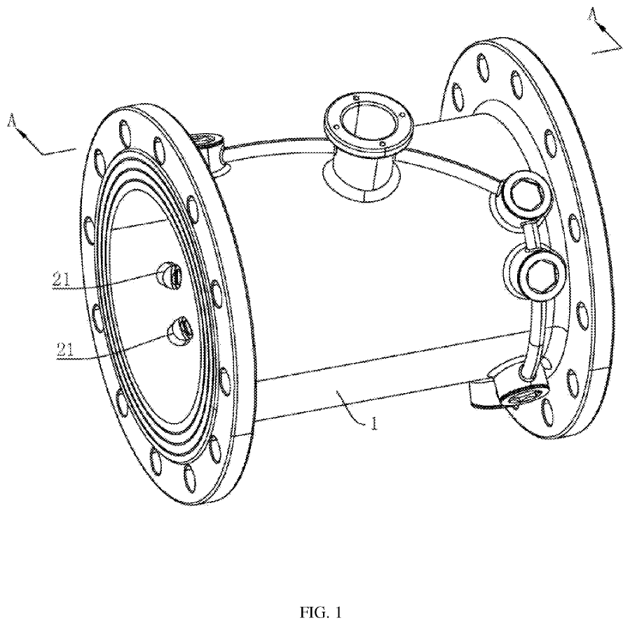

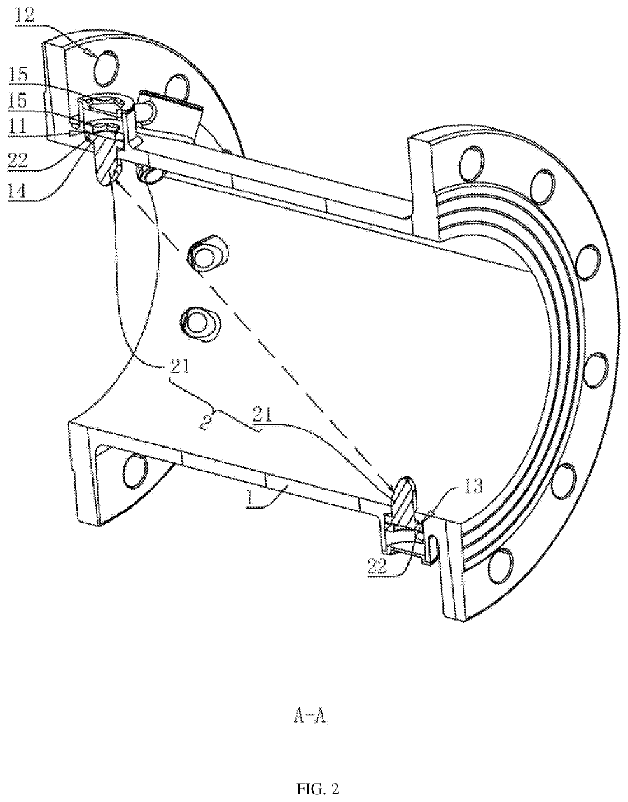

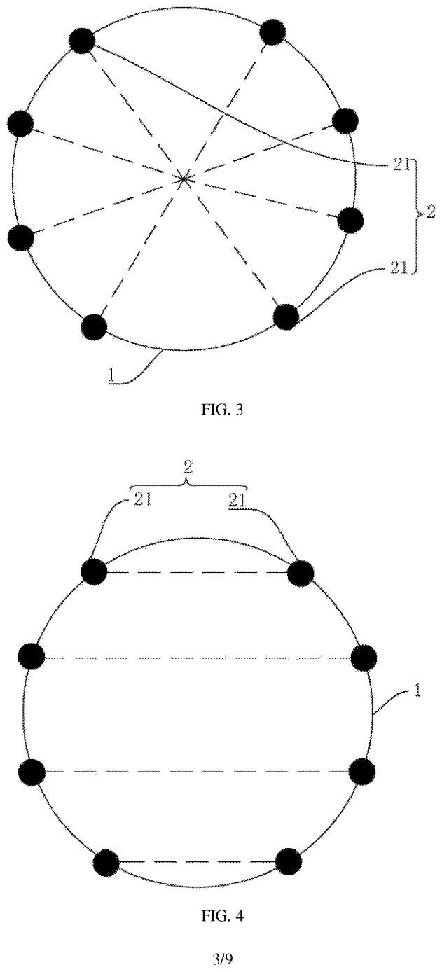

Referring to FIG. 1, FIG. 2 and FIG. 3, the ultra-large diameter straight-through multi-channel ultrasonic fluid measurement device includes a measuring tube body 1 and a plurality of transducer groups 2 provided on the measuring tube body 1. Four transducer groups 2 are provided in Embodiment 1. It should be noted that the number of the transducer groups 2 may be increased or decreased according to actual testing needs. Specifically, each transducer group 2 includes two ultrasonic transducers 21 arranged facing each other. Two ultrasonic transducers 21 belonging to the same transducer group 2 are configured to transmit and receive ultrasonic waves to and from each other. The dashed lines in FIG. 2 and FIG. 3 indicate ultrasonic propagation paths formed between the two ultrasonic transducers 21 belonging to the same transducer group 2. When viewed from an end of the measuring tube body 1 (i.e., as observing the inner wall of the measuring tube body from the end of the measuring tube body 1 along an axial direction of the measuring tube body), the ultrasonic propagation paths generated by all the transducer groups 2 in Embodiment 1 of the present application form an asterisk shape. By increasing the number of the transducer groups 2, the ultrasonic propagation paths can be increased, thereby achieving multi-plane measurement of the fluid and improving measurement accuracy.

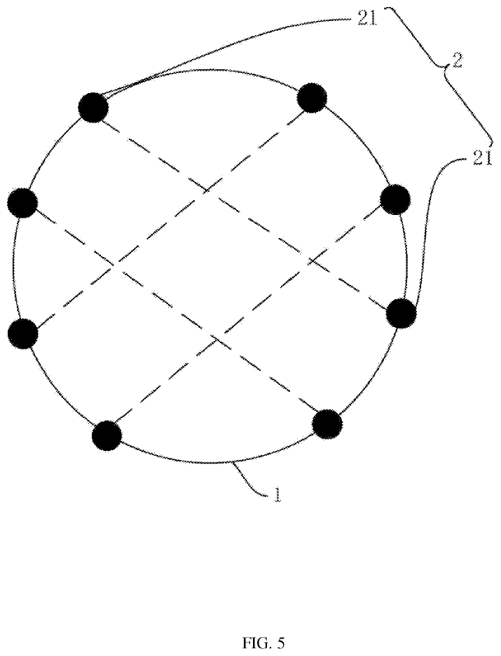

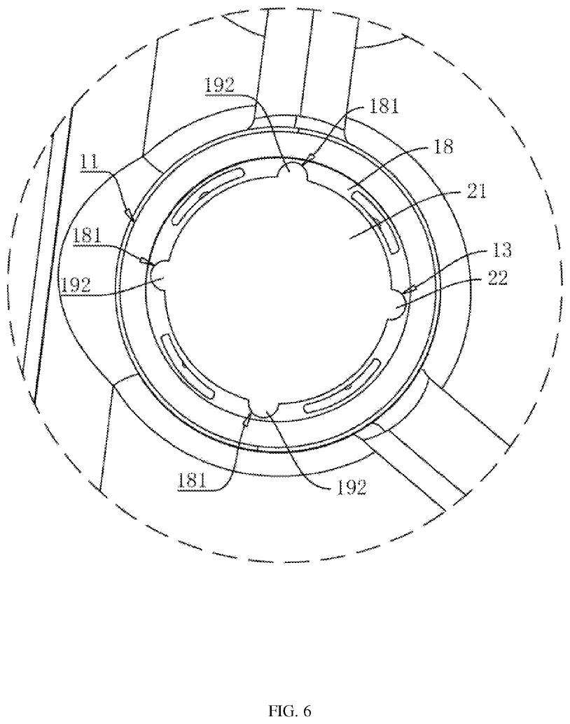

The shape formed by the ultrasonic propagation paths is not limited to the asterisk shape. It can be pre-designed by artificially designing the positions of the mounting holes 11 and the inclination angle of each mounting hole 11 relative to a radial direction of the measuring tube body 1 when the mounting holes 11 are initially formed, so as to ensure that the two ultrasonic transducers of the same transducer group 2 are arranged facing each other. For example, when forming the mounting hole 11, an orientation of the mounting hole 11 relative to the measuring tube body 1 is adjusted to subsequently determine positions of the two ultrasonic transducers of the same transducer group 2, as long as it is always ensured that the two ultrasonic transducers of the same transducer group 2 are arranged facing each other. Accordingly, in other embodiments, the ultrasonic propagation paths viewed from the end of the measuring tube body 1 can also be designed into a four-stroke horizontal shape as shown in FIG. 4, or a grid-like shape as shown in FIG. 5.

Referring to FIG. 1 and FIG. 2, an end of the measuring tube body 1 is provided with threaded holes 12 for connecting a flange disk, so as to connect the measuring tube body 1 and other pipes via the flange, allowing fluid (such as water) from other pipes to flow through the measuring tube body 1, and a flow rate of the fluid is detected via the transducer groups 2. The flow rate detection technology of the ultrasonic transducer 21 is the existing technology and will not be described in detail herein.

Referring to FIG. 1 and FIG. 3, all the ultrasonic transducers 21 are arranged at the ends of the measuring tube body 1. The two ultrasonic transducers 21 belonging to the same transducer group 2 are respectively located at different ends of the measuring tube body 1. All ultrasonic probes located at the same end of the measuring tube body 1 share a single wiring conduit, so that an overall structure of the ultrasonic fluid measurement device simpler and more reliable. In other embodiments, a conventional wiring mode may also be adopted, i.e., each ultrasonic transducer 21 corresponds to one wiring conduit. As viewed from the end of the measuring tube body 1, all the ultrasonic transducers 21 are uniformly distributed along a circumferential direction of the measuring tube body 1. The positional arrangement of the ultrasonic transducers 21 described above not only increases an acoustic path length of ultrasonic signals to improve the dynamic range of the meter measurement, but also enables the measurement of the fluid velocity at different planes even when the fluid to be measured is disturbed, thereby significantly enhancing metering accuracy and measurement stability.

Referring to FIG. 2, a side wall of the measuring tube body 1 adjacent to the end thereof is formed with mounting holes 11 extending therethrough for insertion of the ultrasonic transducers 21. A depth direction of the mounting hole 11 does not intersect with a depth direction of any adjacent threaded hole 12 on the measuring tube body 1. That is, an installation position of the ultrasonic transducer 21 avoids the depth direction of the threaded hole 12, preventing the ultrasonic transducer 21 from obstructing the installation of a bolt into the threaded hole 12.

Referring to FIG. 2 and FIG. 3, the mounting holes 11 are provided in on-to-one correspondence with the ultrasonic transducers 21. A detecting end of each ultrasonic transducer 21 extends through the respective mounting hole 11 and is located inside the measuring tube body 1, and an end surface of the detecting end of the ultrasonic transducer 21 is obliquely arranged. In order to allow the detecting ends of the two ultrasonic transducers 21 belonging to the same transducer group 2 to face each other, thereby ensuring smooth transmission and reception of ultrasonic signals, the other end of each ultrasonic transducer 21 is provided with a positioning protrusion 22. Accordingly, an inner wall of the mounting hole 11 is formed with a positioning groove 13 for receiving the positioning protrusion 22. When the ultrasonic transducer 21 is installed in the corresponding mounting hole 11 and the positioning protrusion 22 is inserted into the positioning groove 13, the detecting ends of the two ultrasonic transducers 21 belonging to the same transducer group 2 face each other.

Referring to FIG. 2, a rubber ring gasket 14 is inserted into the inner wall of the mounting hole 11, and the detecting end of the ultrasonic transducer 21 can extend through the rubber ring gasket 14. When the ultrasonic transducer 21 is inserted into the mounting hole 11, the rubber ring gasket 14 is located between the mounting hole 11 and the ultrasonic transducer 21 and simultaneously abuts against the inner wall of the mounting hole 11 and a peripheral wall of the ultrasonic transducer 21, achieving sealing at a joint between the mounting hole 11 and the ultrasonic transducer 21. In addition, an inner wall at an opening of each mounting hole 11 is threadedly connected with a cover plate 15. The cover plate 15 can be rotated by using an external tool so that the cover plate 15 covers the opening of the mounting hole 11, and the cover plate 15 presses against the end of the ultrasonic transducer 21, enabling the positioning protrusion 22 on the ultrasonic transducer 21 to be fixedly inserted into the positioning groove 13, thus achieving fixed installation of the ultrasonic transducer 21.

An implementation principle of the ultra-large diameter straight-through multi-channel ultrasonic fluid measurement device according to Embodiment 1 of the present disclosure is as follows. The ultrasonic transducers 21 are installed into the mounting holes 11 respectively, and the positioning protrusions 22 are inserted into the positioning grooves 13 respectively, thereby ensuring that the detecting ends of the two ultrasonic transducers 21 belonging to the same transducer group 2 are arranged facing each other. Then, the measuring tube body 1 is connected with a pipeline via flanges. Thereafter, when fluid in the pipeline flows through the measuring tube body 1, an external controller (such as a PLC controller) controls each transducer group 2 to start up sequentially according to a preset order to transmit and receive ultrasonic waves, thus achieving detection of different layers of the fluid to be measured. Subsequently, the controller can calculate a flow velocity and a flow rate of the fluid to be measured based on the transmission and reception data of the ultrasonic waves, and send the calculation results to a smart terminal of the testing personnel, so that the testing personnel are informed of the calculation results.

### Embodiment 2

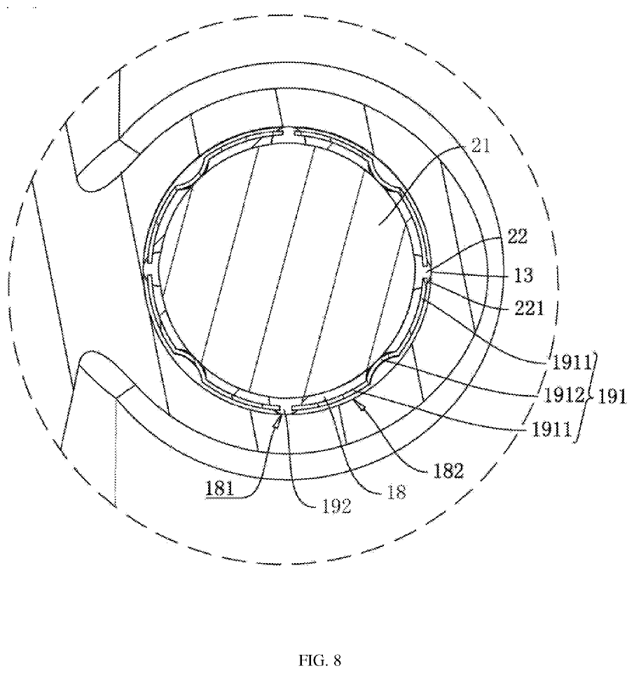

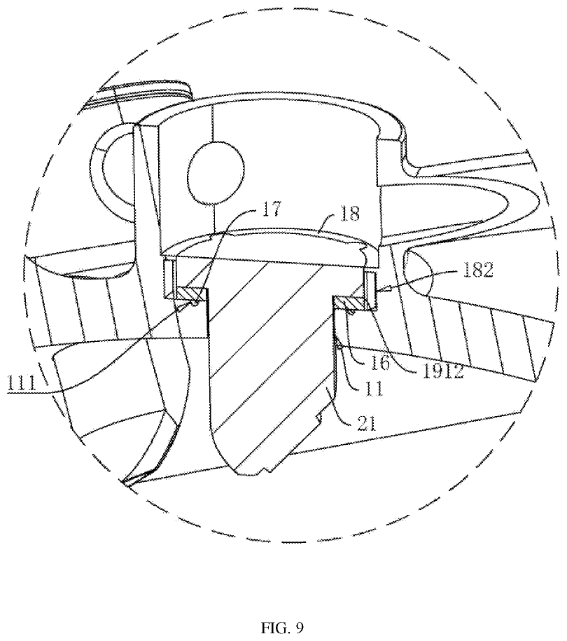

The difference between Embodiment 2 and Embodiment 1 of the present application lies only in the installation manner of the ultrasonic transducers 21 and the mounting holes 11. Specifically, referring to FIG. 7 and FIG. 9, a flexible sealing gasket 16 is inserted into the inner wall of the mounting hole 11. The flexible sealing gasket 16 may be made of rubber. A through hole is formed at a center of the flexible sealing gasket 16 for the detecting end of the ultrasonic transducer 21 to pass through.

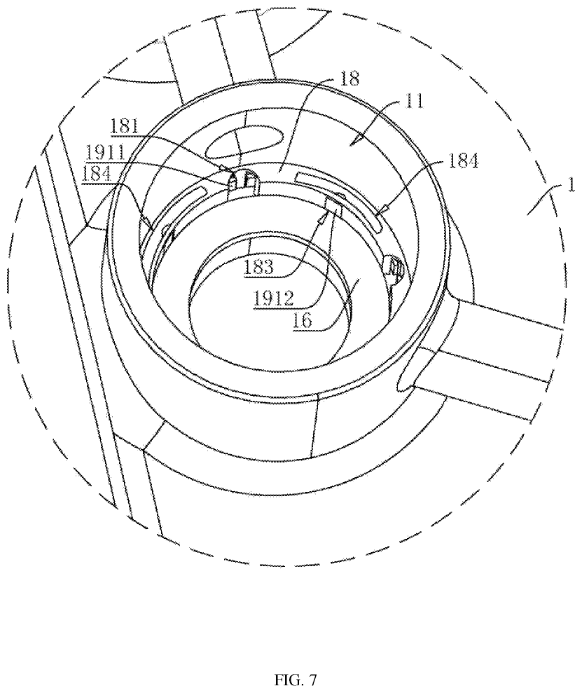

Referring to FIG. 6, FIG. 7 and FIG. 8, a fixing ring block 18 is inserted into the mounting hole 11. The fixing ring block 18 is removably connected to the inner wall of the mounting hole 11. The fixing ring block 18 is located at an outer periphery of the flexible sealing gasket 16 and attached to a peripheral wall of the flexible sealing gasket 16. The positioning groove 13 for insertion of the positioning protrusion 22 is formed on a top surface of the fixing ring block 18. The measuring tube body 1 is provided with a locking assembly near each mounting hole 11. The locking assembly is configured to secure the positioning protrusion 22 within the positioning groove 13. Specifically, the locking assembly includes an elastic locking strip 191 and a plurality of mating protrusions 192. The mating protrusions 192 are disposed on the peripheral wall of the ultrasonic transducer 21. Both the positioning protrusion 22 and all the mating protrusions 192 are uniformly distributed along the circumferential direction of the ultrasonic transducer 21. Accordingly, the top surface of the fixing ring block 18 is further formed with a plurality of mating slots 181. The mating slots 181 are arranged in a one-to-one correspondence with the mating protrusions 192, and each mating protrusion 192 can be inserted into a respective one mating slot 181.

Referring to FIG. 6 and FIG. 7, a cavity 182 is formed in the fixing ring block 18. The cavity 182 communicates with the sealing groove 111 and the positioning groove 13. The elastic locking strips 191 are located in the cavity 182. One elastic locking strip 191 is correspondingly provided between any two adjacent mating slots 181 and between the positioning groove 13 and its adjacent mating slot 181. Each elastic locking strip 191 includes two elastic side pieces 1911 and a mating elastic piece 1912 between the two side pieces 1911. In this embodiment, both the elastic side pieces 1911 and the mating elastic piece 1912 exhibit an arc shape, and the mating elastic piece 1912 protrudes toward a center of the fixing ring block 18. Side walls of the mating protrusions 192 and the positioning protrusion 22 are formed with locking holes 221 for receiving the elastic side pieces 1911.

When the mating protrusion 192 and/or the positioning protrusion 22 is not inserted into the corresponding mounting hole 11, the elastic locking strip 191 is in an undeformed state. At this time, an end of the elastic side piece 1911 away from the mating elastic piece 1912 is inserted into the mating slot 181 or the positioning groove 13. When the mating protrusion 192 is being inserted into the mating slot 181 and the positioning protrusion 22 is being inserted into the positioning groove 13, the elastic side piece 1911 is pressed by the mating protrusion 192 or the positioning protrusion 22 to retract into the cavity 182, and deforms to press against the mating elastic piece 1912. When the mating protrusion 192 is fully inserted into the mating slot 181 and the positioning protrusion 22 is fully inserted into the positioning groove 13, the end of the side piece 1911 re-enters the mating slot 181 or the positioning groove 13 under an elastic force and is inserted into the corresponding locking hole 221. When the end of the side piece 1911 is inserted into the locking hole 221, both the side piece 1911 and the mating elastic piece 1912 still remain in an elastically deformed state. That is, the end of the side piece 1911 abuts against an inner wall of the locking hole 221, thereby achieving a fixed connection between the positioning protrusion 22 and an inner wall of the positioning groove 13 by a combination of a physical plug-in action and an elastic force.

In addition, to facilitate the removal of the ultrasonic transducer 21 from the mounting hole 11, the top surface of the fixing ring block 18 adjacent to each elastic locking strip 191 in this embodiment is formed with a detachment port 184. An inner wall of the detachment port 184 is rotatably connected with a flap configured for opening and closing the detachment port 184. The detachment port 184 communicates with the cavity 182. When the positioning protrusion 22 needs to be disengaged from the positioning groove 13, the detachment port 184 can be opened by rotating the flap in a direction away from the detachment port 184. A human hand or an external tool is inserted into the cavity 182 to press the elastic locking strip 191, so that the elastic locking strip 191 completely retracts into the cavity 182. This causes the side pieces 1911 to disengage from the locking holes 221, and ultimately enables the positioning protrusion 22 to disengage from the positioning groove 13 and the mating protrusion 192 to disengage from the mating slot 181.

Referring to FIG. 7 and FIG. 9, a lower end of the mating elastic piece 1912 passes through the cavity 182 and extends downward to the outer periphery of the flexible sealing gasket 16. The inner wall of the fixing ring block 18 adjacent to each mating elastic piece 1912 is formed with a relief hole 183 extending therethrough. When the mating elastic piece 1912 is in the undeformed state, the lower end of the mating elastic piece 1912 extends through the relief hole 183 and is attached to the peripheral wall of the flexible sealing gasket 16. When the mating elastic piece 1912 is deformed due to being recessed by the side pieces 1911, the mating elastic piece 1912 bends and deforms towards the flexible sealing gasket 16, thereby pressing against the flexible sealing gasket 16, so that the flexible sealing gasket 16 abuts against the peripheral wall of the ultrasonic transducer 21, thereby optimizing the sealing effect.

Moreover, a bottom of the flexible sealing gasket 16 is integrally formed with a mating sealing gasket 17, and a bottom wall of the mounting hole 11 is formed with a sealing groove 111 for receiving the mating sealing gasket 17. The present application further provides that the sealing grooves 111 are arranged in one-to-one correspondence with the relief holes 183, each sealing groove 111 is positioned exactly at a position of the mounting hole 11 near a respective one relief hole 183, and a depth direction of the sealing groove 111 is perpendicular to a direction in which the mating elastic piece 1912 presses against the flexible sealing gasket 16. When the mating elastic piece 1912 presses against the flexible sealing gasket 16, the mating sealing gasket 17 will be compressed and press against an inner wall of the sealing groove 111, thereby enhancing the connection tightness between the flexible sealing gasket 16 and the inner wall of the mounting hole 11, and thus optimizing the sealing performance of the flexible sealing gasket 16 at the joint between the mounting hole 11 and the ultrasonic transducer 21.

### Embodiment 3

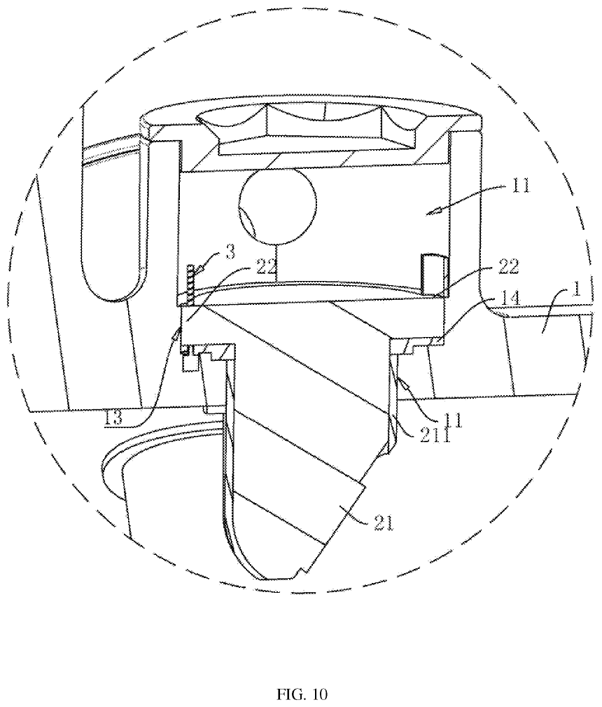

The difference between Embodiment 3 and Embodiment 1 is as follows. Referring to FIG. 10, the ultrasonic transducer 21 is slidably arranged in the mounting hole 11 along the depth direction of the mounting hole 11. The measuring tube body 1 is provided with a driving member 3 configured to drive the ultrasonic transducer 21 to slide and fix a sliding position thereof. Specifically, the driving member 3 may be a combined structure of a motor and a mini lead screw. By connecting a driving end of the motor to an end of the mini lead screw, the mini lead screw is threadedly connected to the peripheral wall of the ultrasonic transducer 21, ensuring that a length direction of the mini lead screw is parallel to the hole depth direction of the mounting hole 11, so that when the mini lead screw rotates, it may drive the ultrasonic transducer 21 to slide along the depth direction. The motor can be controlled by a preset controller, and the controller controls two ultrasonic transducers 21 belonging to the same transducer group 2 to move a specified distance and then stop. It should be noted that the travel distances of the two ultrasonic transducers 21 belonging to the same transducer group 2 are equal. When one ultrasonic transducer 21 moves towards a center of the measuring tube body 1, the other ultrasonic transducer 21 moves away from the center of the measuring tube body 1, thereby ensuring smooth transmission and reception of ultrasonic signals between the two ultrasonic transducers 21 belonging to the same transducer group 2. By controlling the movement of the ultrasonic transducers 21, the installation positions of the ultrasonic transducers 21 can be adjusted on demand, thus further increasing the measurement planes associated with the fluid and improving measurement comprehensiveness.

A surface of the ultrasonic transducer 21 is further provided with a thermal insulation layer 211. The thermal insulation layer 211 is made of a heat-insulating material, such as a heat-insulating metal material. The inner wall of the measuring tube body 1 adjacent to each mounting hole 11 is further provided with a scraper 112. When the ultrasonic transducer 21 is inserted into the mounting hole 11, the scraper 112 is fitted around an outer periphery of the ultrasonic transducer 21 and attached to the peripheral wall of the ultrasonic transducer 21, so as to scrape the peripheral wall of the ultrasonic transducer 21 when the ultrasonic transducer 21 slides along the depth direction of the mounting hole 11, thereby reducing dirt accumulation on the surface of the ultrasonic transducer 21.

The above are merely optional embodiments of the present application, and are not intended to define or limit the scope of protection of the present application. Therefore, any equivalent variations made according to the structures, shapes, and principles of the present application shall all be encompassed within the scope of protection of the present application.

### LIST OF REFERENCE SIGNS

1 measuring tube body
11 mounting hole
111 sealing groove
112 scraper
12 threaded hole
13 positioning groove
14 rubber ring gasket
15 cover plate
16 flexible sealing gasket
17 mating sealing gasket
18 fixing ring block
181 mating slot
182 cavity
183 relief hole
184 detachment port
191 elastic locking strip
1911 side piece
1912 mating elastic piece
192 mating protrusion
2 transducer group
21 ultrasonic transducer
211 thermal insulation layer
22 positioning protrusion
221 locking hole
3 driving member

What is claimed is:

1. An ultra-large diameter straight-through multi-channel ultrasonic fluid measurement device, comprising a measuring tube body, wherein the measuring tube body is provided with a plurality of transducer groups, each of the plurality of transducer groups comprises two ultrasonic transducers arranged facing each other, the ultrasonic transducers of the plurality of transducer groups are arranged at two ends of the measuring tube body, the two ultrasonic transducers belonging to a same one of the plurality of transducer groups are located at the two ends of the measuring tube body respectively, and the ultrasonic transducers of the plurality of transducer groups are distributed along a circumferential direction of the measuring tube body when viewed from an end of the two ends of the measuring tube body,
a side wall of the measuring tube body is formed with a mounting hole for each of the ultrasonic transducers, the mounting hole extends along a radial direction of the measuring tube body, each of the ultrasonic transducers is inserted into the mounting hole along a depth direction of the mounting hole, a surface of each of the ultrasonic transducers is provided with a positioning protrusion, an inner wall of the mounting hole is formed with a positioning groove for receiving the positioning protrusion, and the measuring tube body is further provided with a locking assembly for fixing the positioning protrusion in the positioning groove, and
the locking assembly comprises an elastic locking strip, a side wall of the positioning protrusion is formed with a first locking hole, the elastic locking strip is slidably connected to an inner wall of the positioning groove, and the first locking hole is located in a sliding path of the elastic locking strip.

2. The ultra-large diameter straight-through multi-channel ultrasonic fluid measurement device of claim 1, wherein an end surface of each of the ultrasonic transducers for transmitting and receiving ultrasonic waves is configured as an inclined end surface, and the inclined end surfaces of the two ultrasonic transducers belonging to a same one of the plurality of transducer groups are arranged facing each other.

3. The ultra-large diameter straight-through multi-channel ultrasonic fluid measurement device of claim 1, wherein the locking assembly further comprises a plurality of mating protrusions, the plurality of mating protrusions and the positioning protrusions are arranged along a circumferential direction of each of the ultrasonic transducers, the inner wall of the mounting hole is formed with mating slots for receiving the plurality of mating protrusions, a second elastic locking strip is provided between every two adjacent ones of the mating slots and between the positioning groove and a respective one of the mating slots adjacent to the positioning groove, respectively, the second elastic locking strip comprises two side pieces and a mating elastic piece between the two side pieces, the first locking hole is configured for receiving a first one of the two side pieces, a side wall of each of the plurality of mating protrusions is formed with a second locking hole for receiving a second one of the two side pieces, when the two side pieces and the mating elastic piece are undeformed, an end of each of the two side pieces away from the mating elastic piece is inserted into a respective one of the mating slots or the positioning groove, and when the two side pieces are respectively inserted into the first locking hole and the second locking hole, both the two side pieces and the mating elastic piece are in an elastically deformed state.

4. The ultra-large diameter straight-through multi-channel ultrasonic fluid measurement device of claim 3, wherein the mounting hole is internally provided with a flexible sealing gasket, the flexible sealing gasket is located between a respective one of the ultrasonic transducers and the inner wall of the mounting hole, the flexible sealing gasket is formed with a through hole for a respective one of the ultrasonic transducers to extend through, a lower end of the mating elastic piece extends along a length direction of the mating elastic piece to an outer periphery of the flexible sealing gasket, when the mating elastic piece is undeformed, the mating elastic piece is attached to a peripheral wall of the flexible sealing gasket, and when the two side pieces are respectively inserted into the first locking hole and the second locking hole, the mating elastic piece bends and deforms toward the flexible sealing gasket and presses against the flexible sealing gasket.

5. The ultra-large diameter straight-through multi-channel ultrasonic fluid measurement device of claim 4, wherein a lower surface of the flexible sealing gasket facing the mating elastic piece is integrally formed with a mating sealing gasket, and the inner wall of the mounting hole is formed with a sealing groove for receiving the mating sealing gasket.

6. The ultra-large diameter straight-through multi-channel ultrasonic fluid measurement device of claim 1, wherein each of the ultrasonic transducers is slidably connected within the mounting hole along the depth direction of the mounting hole, and the measuring tube body is provided with a driving member for fixing a sliding position of each of the ultrasonic transducers.

7. The ultra-large diameter straight-through multi-channel ultrasonic fluid measurement device of claim 6, wherein an inner wall of the measuring tube body adjacent to the mounting hole is provided with a scraper, and the scraper is located at an outer periphery of a respective one of the ultrasonic transducers and attached to a peripheral wall of a respective one of the ultrasonic transducers.

8. The ultra-large diameter straight-through multi-channel ultrasonic fluid measurement device of claim 2, wherein different quantities of transducer groups determine different ultrasonic propagation paths and generate different measurement planes, and ultrasonic transducers in the different quantities of transducer groups at the different measurement planes have end surfaces with different inclination angles.
